(19) United States
(12) Patent Application Publication
(10) Pub. No.: US 2010/0316068 A1
(43) Pub. Date: Dec. 16, 2010

(54) Transport Over an Asynchronous XAUI-like Interface

(76) Inventors: Matthew Ornes, Andover, MA (US); Keith Conroy, Perkasie, PA (US)

Correspondence Address: LAW OFFICE OF GERALD MALISZEWSKI, P.O. BOX 270829, SAN DIEGO, CA, 92198-2829, US

(21) Appl. No.: 12/483,711

(22) Filed: Jun. 12, 2009

(51) Int. Cl. H04L 29/02

(52) U.S. Cl. 370/476

(57) ABSTRACT

A system and method are provided for transporting digital information via a modified Attachment Unit Interface (MAUI) or XAUI-like interface. At a transmitter, a synchronous serial stream of digital information is accepted. The serial stream is divided into a sequence of segments. The segments are encapsulated, creating a sequence of packets by adding a start character to the beginning of each segment, and adding a terminate character to the end of each segment. Typically, each segment is disinterleaved across m equal-rate lanes, whose combination is effectively equal to the incoming serial stream data rate, with compensation for added encapsulation characters. The added encapsulation characters may include post-start characters added subsequent to the start character, inter-packet characters added subsequent to the termination character, or a combination of post-start and inter-packet characters.

### BACKGROUND OF THE INVENTION

1. Field of the Invention

This invention generally relates to communications and, more particularly, to a system and method for the communication of information using a XAUI-like interface.

2. Description of the Related Art

XAUI is a standard for extending the XGMII (10 Gigabit Media Independent Interface) between the MAC and PHY layer of 10 Gigabit Ethernet (10 GbE). XAUI is a concatenation of the Roman numeral X, meaning ten, and the initials of Attachment Unit Interface. The XGMII Extender, which is composed of an XGXS at the MAC end, an XGXS at the PHY end and a XAUI between them, is to extend the operational distance of the XGMII and to reduce the number of interface signals. Applications include extending the physical separation possible between MAC and PHY components in a 10 Gigabit Ethernet system distributed across a circuit board.

XAUI uses simple signal mapping to the XGMII, and has independent transmit and receive data paths. Four lanes convey the XGMII 32-bit data and control. Differential signaling is used with a low voltage swing (1600 mVpp), and 8b/10b encoding. A self-timed interface allows jitter control to the physical coding sublayer (PCS). XAUI shares technology with other 10 gigabit per second (Gb/s) interfaces functionality with other 10 Gb/s Ethernet blocks.

The optional XGMII Extender can be inserted between the Reconciliation Sublayer and the PHY (physical layer) to transparently extend the physical reach of the XGMII and reduce the interface pin count from 72 to 16. The XGMII is organized into four lanes with each lane conveying a data octet or control character on each edge of the associated clock. The source XGXS converts bytes on an XGMII lane into a self clocked, serial, 8b/10b encoded data stream. Each of the four XGMII lanes is transmitted across one of the four XAUI lanes.

The source XGXS converts XGMII Idle control characters (interframe) into an 8b/10b code sequence. The destination XGXS recovers clock and data from each XAUI lane and deskews the four XAUI lanes into the single-clock XGMII. The destination XGXS adds to, or deletes from the interframe as needed for clock rate disparity compensation prior to converting the interframe code sequence back into XGMII Idle control characters. The XGXS uses the same code and coding rules as the 10 GBASE-X PCS and PMA specified in Clause 48 of the IEEE 802.3 Specification. Each of the 4 Receive and Transmit lanes operates at a rate of 3.125 Gbs/s.

Capabilities have been built into XAUI to overcome the inter-lane signal-skewing problems using a type of automatic de-skewing. Signals can be launched at the transmitter end of a XAUI line without precisely matching the routing of the four lanes, and the signals will be automatically de-skewed at the receiver.

The implementation of XAUI as an optional XGMII Extender is primarily intended as a chip-to-chip (integrated circuit to integrated circuit) interface implemented with traces on a printed circuit board. Where the XGMII is electrically limited to distances of approximately 2 to 3 inches, the XGMII Extender allows distances up to approximately 25 inches.

The XGMII Extender supports the 10 Gb/s data rate of the XGMII. The 10 Gb/s MAC data stream is converted into four lanes at the XGMII (by the Reconciliation Sublayer for transmit or the PHY for receive). The byte stream of each lane is 8b/10b encoded by the XGXS for transmission across the XAUI at a nominal rate of 3.125 GBaud. The XGXS at the PHY end of the XGMII Extender (PHY XGXS) and the XGXS at the RS end (DTE XGXS) may operate on independent clocks.

The XGMII Extender is transparent to the Reconciliation Sublayer and PHY device, and operates symmetrically with similar functions on the DTE transmit and receive data paths. The XGMII Extender is logically composed of two XGXSs interconnected with a XAUI data path in each direction. One XGXS acts as the source to the XAUI data path in the DTE transmit path and as the destination in the receive path. The other XGXS is the destination in the transmit path and source in the receive path. Each XAUI data path is composed of four serial lanes. All specifications for the XGMII Extender are written assuming conversion from XGMII to XAUI and back to XGMII, but other techniques may be employed provided that the result is that the XGMII Extender operates as if all specified conversions had been made. One example of this is the use of the optional XAUI with the 10 GBASE-LX4 8b/10b PHY, where the XGXS interfacing to the Reconciliation Sublayer provides the PCS and PMA functionality required by the PHY. An XGXS layer is not required at the PHY end of the XAUI in this case. However, means may still be required to remove jitter introduced on the XAUI in order to meet PHY jitter requirements.

Other conventional protocols used to carry frames (or framed data) include, but are not limited to, the following protocols that have 10 G embodiments: SFI (SFI-4.x), SFI-5S, TFI (TFI-4.x), and XFI. Other 10 G protocols and other non-10 G protocols are also used to carry frames (or framed data).

It would be advantageous if framed or non-framed data, not in accordance with the IEEE 802.3 specification, could be carried through a XAUI-like interface.

### SUMMARY OF THE INVENTION

The system and method described herein carry non-framed, or asynchronous framed data, for a variety of different protocols as if it were framed, via a XAUI-like interface. For example, an ODU-2 frame can be carried over an AUI-like (XAUI-like) interface that might be asynchronous to the frame rate (and/or bit rate). As noted above, the AUI interface is a simple, commonly used, and well understood protocol. Further, transporting a framed protocol (e.g., ODU-2) over AUI provides a cost effective way to add such a capability to a device that already has the AUI interface and protocol stack. Transporting other framed protocols, (e.g., ODU-2/ODU-1) other than Ethernet frames over the XAUI interface, provides a cost effective way to add such a capability to a device that already has the AUI interface and protocol stack. A single standard interface can be designed to support multiple protocols in order to save cost and power. For example, in today's market the XAUI interface is only designed for 10 G Ethernet/Fibre Channel packet transfer. In the disclosed system, an OTU-2 protocol frame can be forward error correction (FEC) decoded and deinterleaved into 4 packets to be transferred over the XAUI interface.

Accordingly, a method is provided for transporting digital information via a modified Attachment Unit Interface (MAUI) or XAUI-like interface. At a transmitter, an electromagnetic waveform is accepted representing a synchronous serial stream of digital information. The serial stream is divided into a sequence of segments. The segments are encapsulated, creating a sequence of packets by adding a start character to the beginning of each segment, and adding a terminate character to the end of each segment. Then, an electromagnetic waveform representing the sequence of packets is asynchronously (with respect the incoming serial stream) transmitted.

Typically, the method disinterleaves each segment across m lanes. If the serial stream is accepted at a first data rate, equal-rate disinterleavered lanes are created at a second data rate, whose combination is effectively equal to the first data rate, with compensation for added encapsulation characters. The added encapsulation characters may include post-start characters added subsequent to the start character, inter-packet characters added subsequent to the termination character, or a combination of post-start and inter-packet characters. More explicitly, the post-start and inter-packet characters may be idle characters, fill-data characters, or in-band communication channel characters.

Additional details of the above-described method and a device for the transport of digital information via a MAUI interface are provided below.

### BRIEF DESCRIPTION OF THE DRAWINGS

FIG. 1 is a schematic block diagram of a device for the transport of digital information via a modified Attachment Unit Interface (MAUI) interface.

FIG. 2 is a schematic block diagram depicting a variation of the MAUI interface device of FIG. 1.

FIG. 3 is a diagram depicting a first encapsulation example.

FIG. 4 is a diagram depicting a second encapsulation example.

FIG. 5 is a diagram depicting a third encapsulation example.

FIG. 6 is a diagram depicting one example of using four lanes of XAUI to transport an ODU-2 frame.

FIG. 7 is a diagram depicting a second example of using four lanes of XAUI to transport framed data.

FIG. 8 is a diagram depicting a third example of using four lanes of XAUI to transport framed data.

FIG. 9 is a diagram depicting a fourth example of using four lanes of XAUI to transport constant-bit rate data streams.

FIG. 10 is a flowchart illustrating a method for transporting digital information via a MAUI interface.

### DETAILED DESCRIPTION

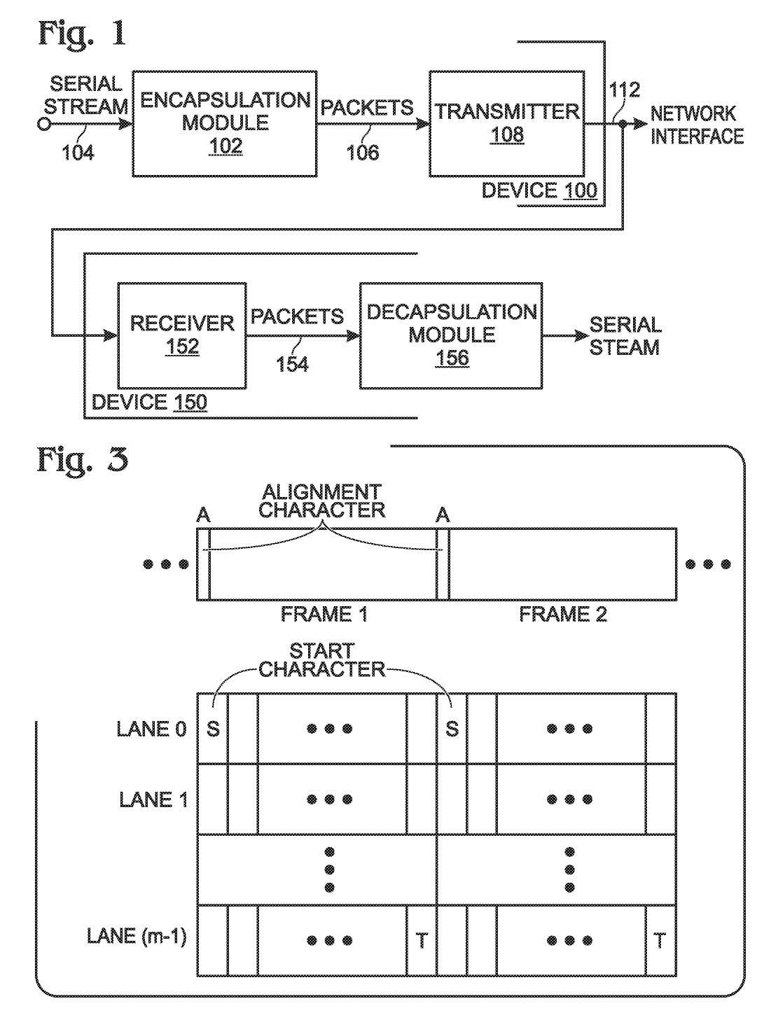

FIG. 1 is a schematic block diagram of a device for the transport of digital information via a modified Attachment Unit Interface (MAUI) interface. The device 100 comprises an encapsulation module 102 having an upper level interface on line 104 to accept an electromagnetic waveform representing a synchronous serial stream of digital information. For example, the upper level interface may be connected to an upper layer as expressed by the International Organization for Standardization (ISO) 7-layer model. The encapsulation module 102 divides the serial stream into a sequence of segments, encapsulates each segment, and creates a packet by adding a start character to the beginning of each segment and a terminate character to the end of each segment. The encapsulation module 102 supplies a sequence of packets on line 106.

A transmitter 108 has an interface to accept the sequence of packets and a network interface on line 112 for asynchronously transmitting an electromagnetic waveform representing the sequence of packets. In one aspect, the transmitter is a PHY transmitter. In another aspect, the encapsulation module 102 selects the size of each segment, so that the transmitter 108 is capable of transmitting a sequence of variable-length packets.

Also shown is a device 150 for the receiving digital information via a MAUI interface. The device 150 is comprised of a receiver 152 having a network interface on line 112 to accept the electromagnetic waveform representing the asynchronously sequence of packets, and an interface on line 154 to supply the sequence of packets. A decapsulation module 156 has an interface on line 154 to accept the sequence of packets. The decapsulation module 156 decapsulates each packet, creating segments by removing a start character from the beginning of each packet and a terminate character from the end of each segment. The segments are combined to supply an electromagnetic waveform on line 158 representing a synchronous serial stream of digital information via an upper level interface. The receiving process is essentially the reverse of the transmission process, and in the interest of brevity, these redundant details are not repeated.

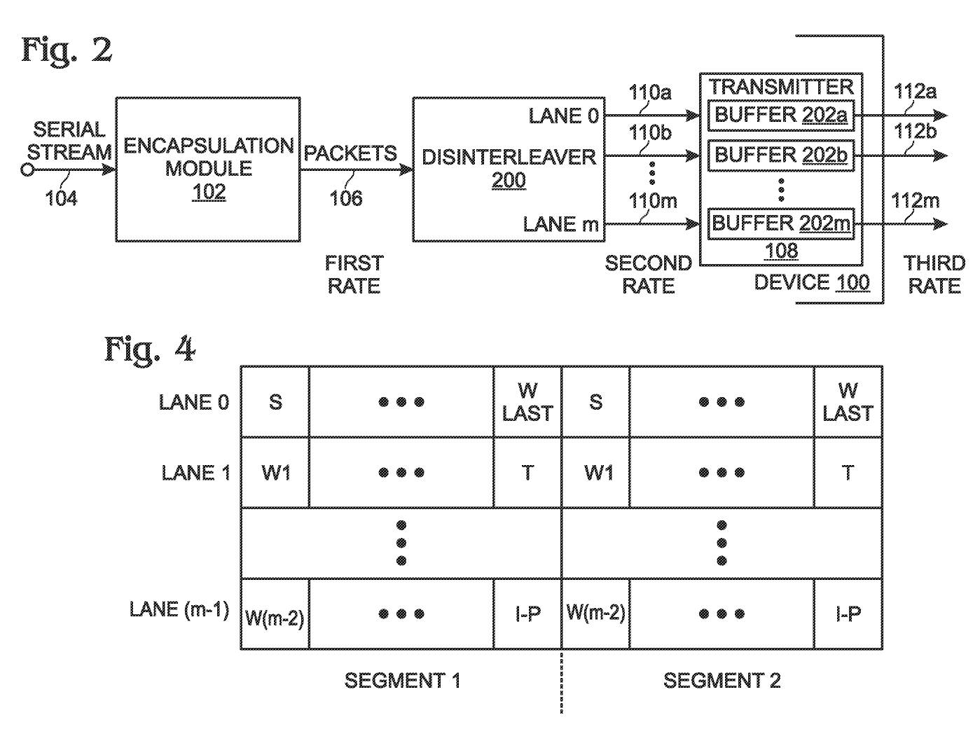

FIG. 2 is a schematic block diagram depicting a variation of the MAUI interface device of FIG. 1. In this aspect, a disinterleaver 200 interposed between the encapsulation module 102 and the transmitter 108. The disinterleaver 200 accepts the sequence of packets and supplies each segment disinterleaved across m lanes (lines 110a through 110m), where m is a variable not limited to any particular value. The transmitter 108 has m parallel input interfaces to accept the disinterleaved lanes and m parallel network interfaces (lines 112a through 112m) corresponding to the m lanes. Note: in some aspects of the device (not shown), the encapsulation and disinterleaving functions are combined in a single module.

Typically, the encapsulation module 102 accepts the serial stream at a first data rate, and the disinterleaver 200 creates equal-rate lanes at a second data rate, whose combination is effectively equal to the first data rate, with compensation (speed-up) for added encapsulation characters. Some exemplary encapsulation characters include post-start characters added subsequent to the start character, inter-packet characters added subsequent to the termination character, or a combination of post-start and inter-packet characters. Further, the post-start and inter-packet characters may be idle characters, fill-data characters, or in-band communication channel characters.

Start, inter-packet, and terminate characters are special multi-bit symbols or words with a pattern of bit values recognized by communicating devices as having a special significance. As such, these bit patterns can be used for control and for the establishment of boundaries between packets. This concept of control characters is well understood in the art. There are special 4-word (4-character) sequences defined in XAUI that are used for “link status” indication (called “sequence ordered-sets”), which can be used for inter-packet characters.

The receiving process is essentially the reverse of the transmission process, and in the interest of brevity, these redundant details are not repeated. Although not explicitly shown in FIG. 2, such a receiver would comprise receiving, interleaving, and decapsulation modules.

FIG. 3 is a diagram depicting a first encapsulation example. The encapsulation module accepts frames of information, where each frame includes at least one frame alignment character at the start of each frame, and replaces the alignment character with a start character. As used herein, the terms frame and framed data are interchangeably and no distinction between the two is implied. It should also be understood that the device also operates with arbitrary CBR (constant bit rate) data streams as well as framed data, as shown below.

FIG. 4 is a diagram depicting a second encapsulation example. The encapsulation module adds the start character as the first character in lane 0 of m lanes, and the terminate character into lane x, subsequent to the last word in the segment. The disinterleaver disinterleaves a first word (W1) in the segment into lane 1, subsequent to the start character, and adds inter-packet characters (I-P) to lanes (x+1) through (m−1), subsequent to the terminate character. In this example, the last word in the segment is placed in lane 0 (x−1), so that the terminate character is placed in lane 1 (x). However, the algorithm works regardless of which lane the terminate character is placed. In the case where the terminate character is placed in lane (m−1), inter-packet characters are not necessary. However, in this case the terminate character could also be followed by m inter-packet characters.

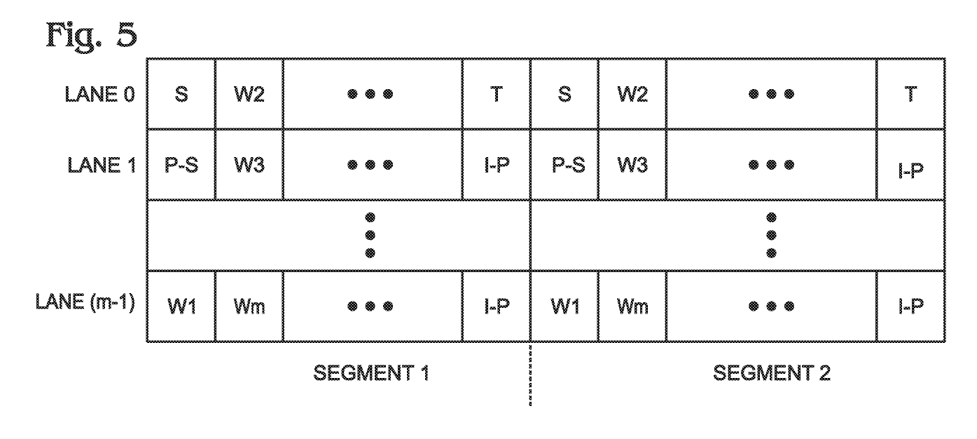

FIG. 5 is a diagram depicting a third encapsulation example. In this aspect the encapsulation module adds the start character as the first character in lane 0 of m lanes, and the terminate character subsequent to the last word in the segment. The disinterleaver adds post-start characters (P-S) to (x−1) lanes subsequent to the start character, disinterleaves a first word in the segment into lane x, subsequent to a last post-start character, and adds inter-packet characters to lanes subsequent to the terminate character. The first word in the segment need not be placed in any particular lane. That is, the number of post-start characters is not limited to any particular number or lane placement. Likewise, the last word in the segment need not be placed into any particular lane, and the inter-packet characters are not limited to any particular number or lane placement.

Returning to FIG. 2, it should be understood that the transmitter 108 is asynchronous with respect to the input serial data stream on line 104. Thus, there may be variations in the two clock controlling lines 104 and 112. However, encapsulation characters can be used as fill characters to compensate for these variations. As shown, the transmitter 108 includes m transmit buffers 202a through 202m. Each buffer 202 fills from a corresponding lane 110 at the second data rate. The transmitter 108 compares the second data rate to a third data rate, at which the packets are transmitted on lines 112a through 112m. The transmitter 108 modifies the number of inter-packet characters to compensate for differences between the second and third data rates, and draining each buffer 202 at the third data rate for transmission on a corresponding line 112. The concept of mapping fill characters into a buffer being filled and drained at different rates is well understood in the art.

The logic portions of the above-described modules may be enabled in hardware using logic circuitry or programmable gate arrays. These modules may also be enabled, or partially enabled as processor software instructions stored as an application in memory (not shown), and executed by a processor (not shown).

### Functional Description

The IEEE 802.3 standard outlines a XAUI interface protocol that is logically equivalent to the 10 GBASE-LX4 protocol used for the transport of variable sized 10 GEthernet packets/frames. The XAUI/10 GBASE-LX4 protocol provides for packet-framing of the Ethernet packet using a /S/ start character and a /T/ termination character, as well as /I/ idle characters for sync, align, and rate adaptation.

These same /S/ start, /T/ termination, and /I/ idle characters (within //S// start, //T// termination, and //I// idle ordered sets), as well as other encapsulation characters, are compliant with the 802.3 XAUI/10 GBASE-LX4 standards, but the encapsulated “packet” is a packet/frame (or a portion of a frame that has been segmented) other than 10 GEthernet.

Generally, the device disclosed in FIG. 2 is able to treat a generic, fixed-sized “frame” of data (e.g. 15296byte ODU-2 frame) as a XAUI “packet”, such that it is stripped (demutiplexed) across the four lanes of XAUI. Further, any bandwidth (time) of the XAUI that is not needed by the generic, fixed-sized frame of data (the time between frames, that is) is filled with encapsulation characters, such as /I/ characters, which are “idle” characters, as defined in the IEEE 802.3 standard.

In the example of a 15296-byte ODU-2 frame, the first byte (like the 10 GE packet) is a known/fixed value (e.g., f6 hex.) The first byte can be replaced with /S/, which is a XAUI control character. Then, the next 15295 bytes of the ODU-2 frame are sent, followed by /T/, another recognized control character. Inter-packet (e.g., idle) characters may be sent until the next ODU-2 frame is to be transferred over the XAUI.

The idea can be generalized to any other fixed-sized “frame” of data, such as a SONET frame. In addition, some “frames” may be split into “sub-frames” of data. If a frame has a first byte that is not fixed/known, such that replacing it with a /S/ character may cause a loss of information, /S/ characters can be added before the first byte of the frame. Further, a configurable (known) number of filler/idle characters can be placed after the /S/ and before the first byte of the frame/sub-frame, possibly done so that the first byte of the frame/sub-frame is transmitted on lane 0.

This methodology permits ODU-2 frames to be transmitted over XAUI, or an ODU-1/lane over XAUI by muxing the ODU1 into ODU-2. Other protocols that can be handled in a similar manner include:

ODU-2 over CX-4 (XAUI)—Interconnects (Bit/Byte interleaver/deinterleaver);

ODU-2 over LX-4 (XAUI)—Interconnects (Bit/Byte interleaver/deinterleaver);

OTU-2/ODU-2/lane over CX4 (XAUI)—40G design (expand to 100G-120G);

OTU-2/ODU-2/lane over LX4 (XAUI)—40G design (expand to 100G-120G);

ODU-1/lane over CX_{—}4; and,

ODU-1/lane over LX-4.

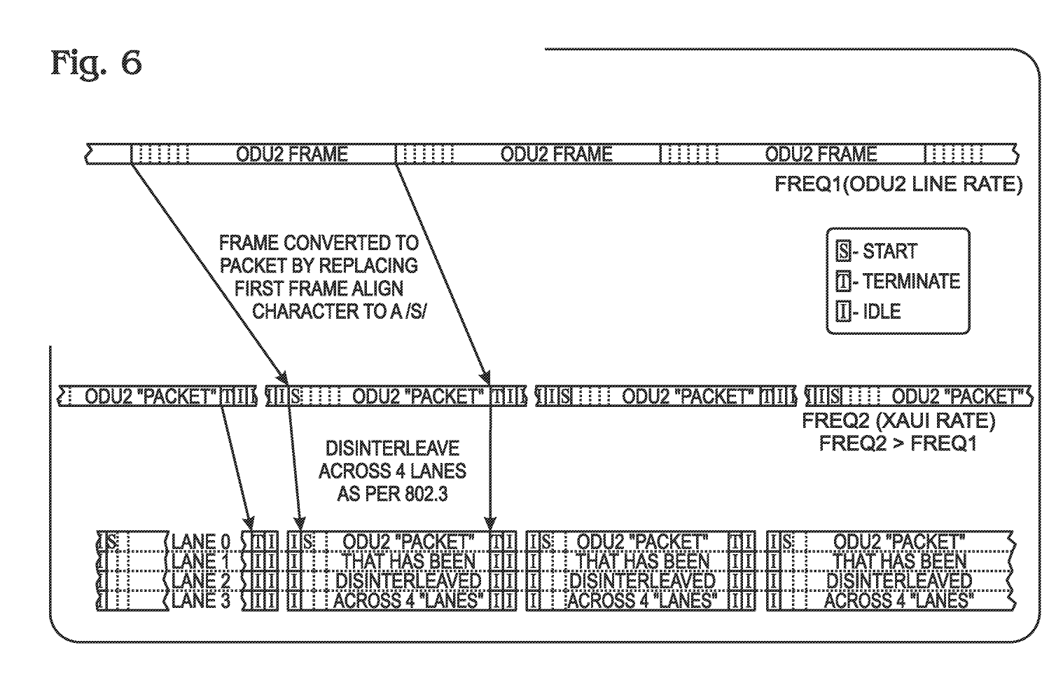

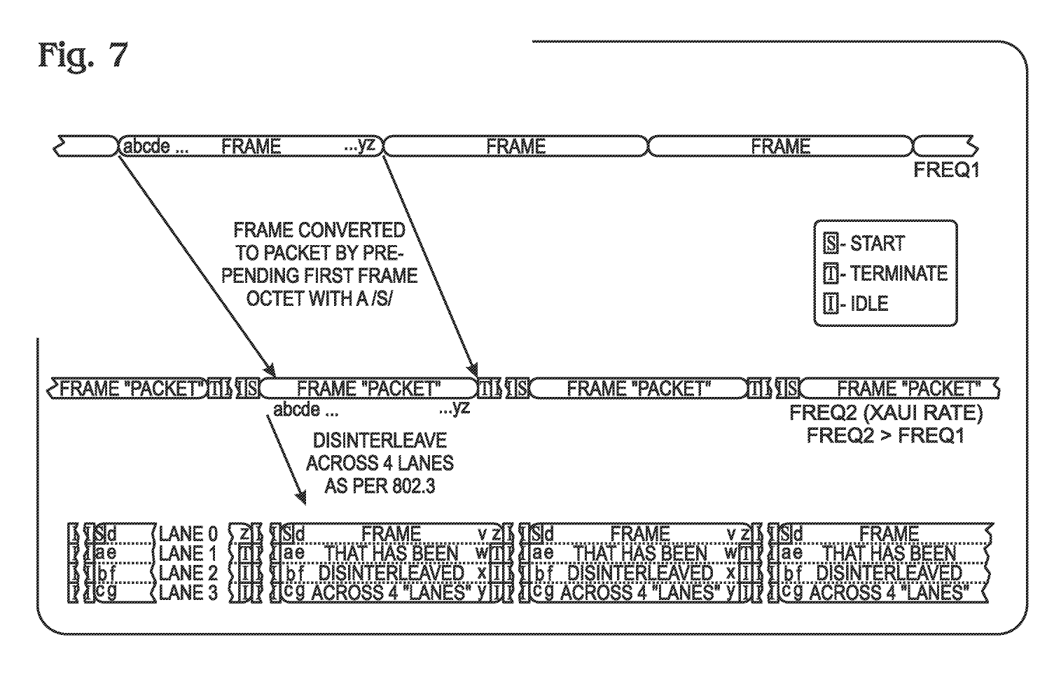

FIG. 6 is a diagram depicting one example of using four lanes of XAUI to transport an ODU-2 frame. In one direction, the ODU-2 frame is further encapsulated in a XAUI-like protocol. The first byte (byte 0) of the ODU-2 frame is a fixed value of 0×F6 (hex) and is replaced with the (8b/10b encoded) /S/ start character that is placed in lane 0 of the XAUI-like interface. Subsequent bytes of the ODU-2 (bytes 1 to 15295) are 8b/10b encoded and disinterleaved across the four lanes, one byte at a time, in same way XAUI does with a 10 GEthernet frame. Directly following the ODU-2 packet, a /T/ terminate character is added to lane 0 (since the ODU-2 frame size is a multiple of four bytes and there are four lanes) and the other 3 (three) lanes are filled with /K/ sync/idle characters

Until the next ODU-2 frame is ready (available) to be disinterleaved onto the XAUI-like interface, the four lanes of the XAUI-like interface are filled with encapsulation characters (e.g., //K// sync, //A// align, and //R// skip ordered sets) in the same manner as defined in IEEE 802.3 clauses, including clause 48.

The ODU-2 rate is not required to be synchronous to the XAUI-like interface rate. The number of encapsulation characters is not fixed and depends on the rate difference between the received ODU-2 rate and the outgoing XAUI-like interface rate. A minimum XAUI-like interface rate is required so as to support the overhead of encapsulation (//T// character ordered set), 8b/10b encoding, and mandatory //I// ordered sets for a given ODU-2 rate, but the XAUI-like interface rate can be any rate equal to or faster than that rate. The faster the XAUI-like rate for a given ODU-2 rate, the more //I// ordered sets there will be on average between ODU-2 frames.

In the other direction, the XAUI-like interface uses received encapsulation characters to perform the following IEEE 802.3 clause 48-like functions: sync (code group alignment), align (lane/column alignment), and skip (rate adaptation). Upon reception of a /S/ character (in lane 0, as in XAUI), the XAUI-like interface will replace the /S/ character with the fixed value ODU-2 A1 character (0×F6 hex). The characters from lanes 1 to 3, as well as the characters from all lanes in subsequent columns until the /T/ terminate character in lane 0, are treated as /D/ data bytes, 8b/10b decoded, and interleaved to provide the 15296 byte (octet) ODU-2 frame.

Just as for the first direction, the XAUI-like interface rate is not required to be synchronous to the ODU-2 rate. The XAUI-like interface contains encapsulation character ordered sets (e.g., //K// sync, //A// align, and //R// skip ordered sets) until lane 0 contains another /S/ character to indicate the start of a new ODU-2 frame. That is, the XAUI-like interface is filled with inter-packet characters until the next ODU-2 frame is ready (available).

The above encapsulation method supports any encapsulated protocol with a fixed (known, deterministic) first byte of the frame, such as SDH, SONET, and ODU-k.

FIG. 7 is a diagram depicting a second example of using four lanes of XAUI to transport framed data. Alternatively, the first byte of the frame could be placed in lane 1 with the /S/ character in lane 0. This method would support the transport of frame protocols for which the first byte is not a fixed value and when that first byte must be transported in a transparent manner. The /S/ character would have to be added to the packet-framing overhead computation when determining the minimum frequency of the XAUI-like interface for a given frame rate.

However, in the case of ODU-2 frames, the ODU-2 frame size is divisible by 4 bytes and so the /T/ character would be in a //T// ordered set that is the same distance from the //S// ordered set as it would be if the /S/ character were to overwrite the first byte. Instead of a /T/ character in lane 0 and inter-packet (e.g., /K/) characters in lanes 1, 2, and 3 (see FIG. 6), the final ODU-2 byte is positioned in lane 0, the /T/ character in lane 1, and /K/ characters in lanes 2 and 3. The minimum bandwidth requirement for this alternative packet-framing of ODU-2 is the same as in FIG. 6.

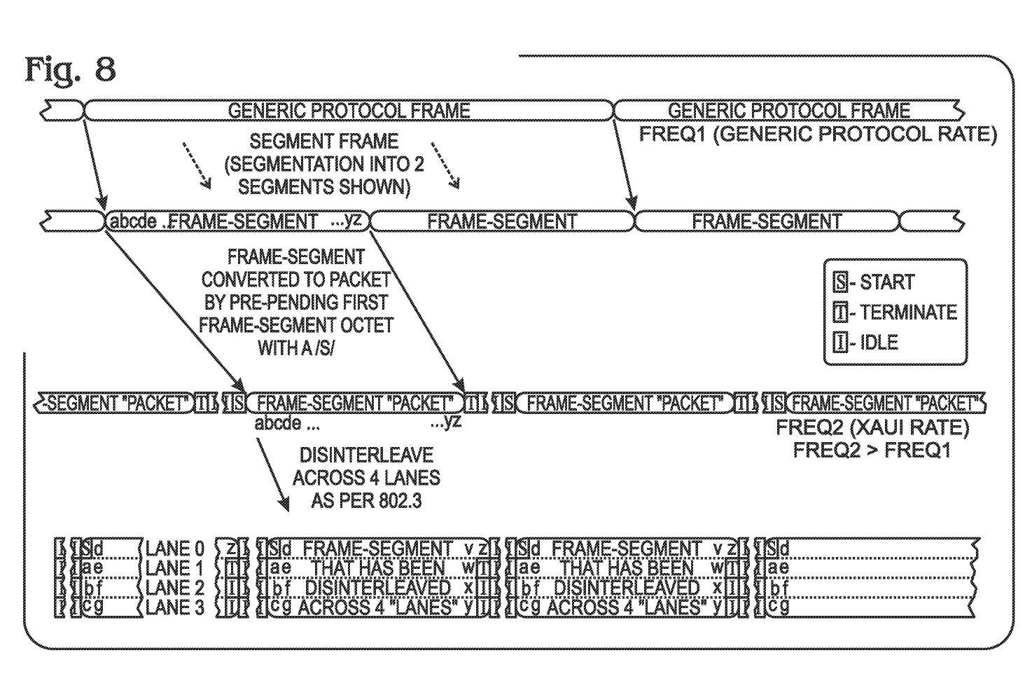

FIG. 8 is a diagram depicting a third example of using four lanes of XAUI to transport framed data. Alternatively, the frame could be segmented into frame-segments, where each frame-segment is transported over the XAUI-like interface. The first byte of the frame-segment could be placed in lane 1 with the /S/ character in lane 0. This method supports the transport of frame-segments without regard to what the first byte of the frame-segment carries. The /S/ character is added to the packet-framing overhead computation when determining the minimum frequency of the XAUI-like interface for a given frame rate.

In the case of any frame-segment size that is divisible by 4 bytes, the /T/ character would be in a //T// ordered set that is the same distance from the //S// ordered set as it would be if the /S/ character were to overwrite the first byte. Instead of a /T/ character in lane 0 and inter-packet (e.g., /K/) characters in lanes 1, 2, and 3 (see FIG. 6), the packet-framing method that places the frame-segment's first byte in lane 1 with the /S/ character in lane 0 has the final ODU-2 byte in lane 0, a /T/ character in lane 1, and /K/ characters in lanes 2 and 3. The minimum bandwidth requirement is the same as the packet-framing method of replacing the first byte of the frame-segment with the /S/ character.

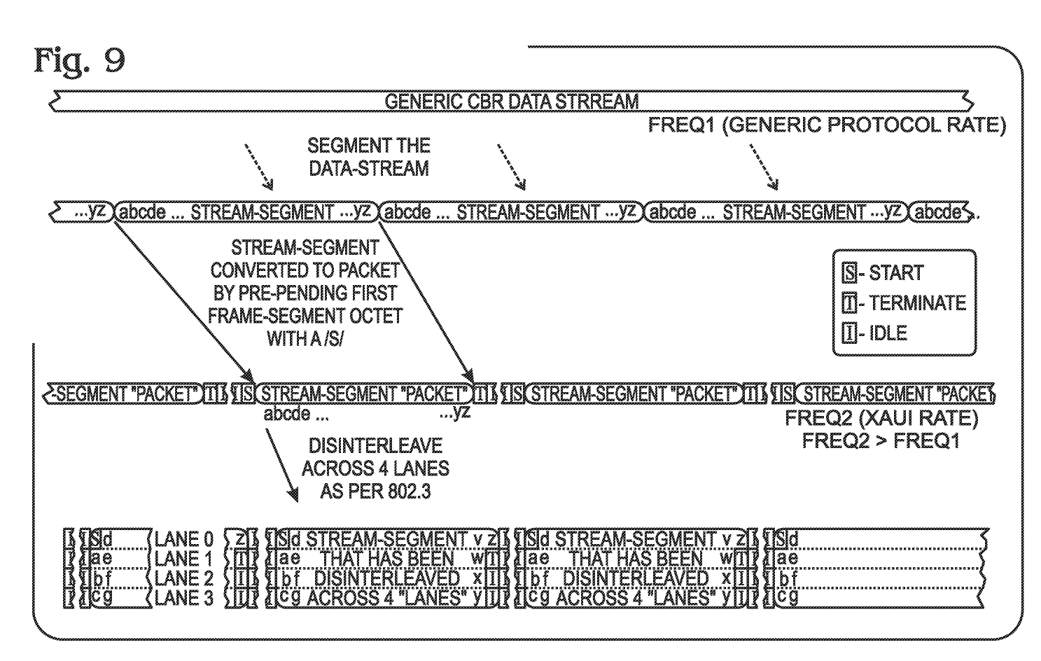

FIG. 9 is a diagram depicting a fourth example of using four lanes of XAUI to transport constant-bit rate data streams. A constant-bit-rate (CBR) data stream can be segmented into stream-segments, where each frame-segment is transported over the XAUI-like interface. The first byte of the frame-segment can be placed in lane 1 with the /S/ character in lane 0. This method supports the transport of stream-segments without regard to what the first byte of the frame-segment carries. The /S/ character is added to the packet-framing overhead computation when determining the minimum frequency of the XAUI-like interface for a given frame rate.

The XAUI-like interface can transport either a fully compliant frame or a partially filled compatible frame that the receiving device will fill. For example, an ODU-2 frame transported over the XAUI-like interface might have empty (zero-filled) data in any set of fixed or device-configurable overhead bytes—that is, OPU-2 data can be transported in an incomplete ODU-2 frame.

Instead of disinterleaving an ODU-2 across four lanes of a XAUI-like interface, the ODU-2 could be muxed/demuxed from/to ODU-1 frames that are each transported across one lane, using equivalent encapsulation, alignment, and rate adaptation techniques. The same could be applied to types of digital multiplexing hierarchies, like SONET, SDH, PDH, and OTN.

The packets do not all need to be of the same size. They can be variable sized. The method can be used for packet-framing and transporting many different framing protocols via AUI-like interfaces: ODU-k; OPU-k; OTU-k (with or without the FEC bytes populated); SONET STS-Nc; SDH; and PDH.

The method is directly applicable to AUI-like interfaces such as XAUI, and 40G or 100G XAUI-like IEEE standards, such as XLAUI and CAUI. The AUI-like interface can be configured to carry the “clock timing” information (clock frequency) of the recovered fiber frequency (for receive) or desired fiber frequency (for transmit). A fixed ratio between the high-speed fiber and AUI can be employed to keep them frequency locked (e.g., 0 ppm difference).

For example, if the line rate is OTU-2 and the XAUI carries ODU-2, the XAUI-like rate could be 20/64ths. The recovered (received) line rate (f1) can be used to generate a XAUI-like bit rate that is f1*20/64. The device receiving that XAUI-like interface can take the f1*20/64, multiply it by 64/20, and recover the original f1 rate. 20/64 is a sufficiently high rate to support the ODU-2 over XAUI-like interface where the serial bit interface is an OTU-2:
ODU-2 rate=f[OTU-2]*(239/255)
ODU-2 rate over XAUI=f[OTU-2]*(239/255)*(1/4)*(10/8)*(1+XAUI_OH_per_ODU2/bytes_per_ODU2)
ODU-2 rate over XAUI<f[OTU-2]*20/64.

The IEEE 802.3 standard has strict frequencies, protocols, and usages defined for the AUI interfaces. This system and method disclosed herein use the concepts defined in the IEEE standards that permit the use of rates other than the IEEE AUI rates—rates that are customized for a particular application. Further, clients other than Ethernet packet data or 10G Fibre channel data can be carried, including any CBR data stream. The transport of a CBR data stream can be accomplished using fewer (or slower) “lanes” than is conventional.

Some prior art methods of carrying CBR data stream require more lanes (e.g., 10 G transmissions—SFI-4.1 requiring 16 lanes vs. XAUI requiring 4 lanes). The smaller number of lanes relative to these prior art can be a significant savings in device area/pins, board real estate (area), backplane resources, etc.

Some prior art methods of carrying CBR data stream require a higher lane bandwidth (e.g., 10 G transmissions—XFI requiring ˜10 G lanes vs. XAUI requiring ˜3.2 G lanes). The lower bandwidth per lane relative to these prior art methods can significantly reduce the complexity in designing and building devices, routing boards and backplanes, etc, as well as improve signal integrity. The higher frequencies of the prior art can lead to more involved analysis, more careful treatment of the wires, etc.

The transport of CBR data stream uses an asynchronous interface. Some prior art methods (e.g., TFI) require that the physical layer of transport (the 0s and 1s on the wire) be strictly synchronous to the CBR data stream being carried.

The system and methods disclosed herein decouple the strict frequency relationship between the physical layer frequency and the framed data frequency. The advantages include, but are not limited to:

Simpler clock design potentials, especially when the prior art has a non-integer ratio between the physical layer and the framed data;

Physical layer clock can be locally generated and not dependent on recovery from input signal (e.g., no need for fail-over during loss-of-signal or loss-of-clock type conditions);

Reduced EFI due to multiple frequencies;

A backplane (switched or unswitched) can have a single, fixed frequency carrying any/all AUI-like packets, regardless of the protocol or rate of carried framed signal;

less ppm precision on XAUI ref clock, i.e. less costly clock generators (e.g., XTALs).

The transport of CBR data stream can be accomplished using technology or devices from outside the normal “transport” market. The use of AUI-like protocol to transport frames allows a system designer to utilize devices and/or technology from markets other than those to which they are limited when using prior art. The AUI protocols are supported by many technologies in the datacom market and these technologies would then be available to anyone using the invention. For example, the use of a XAUI-like protocol as an interconnect carrying CBR data stream allows a system to use backplane ECC technology designed for the 8b/10b XAUI protocol.

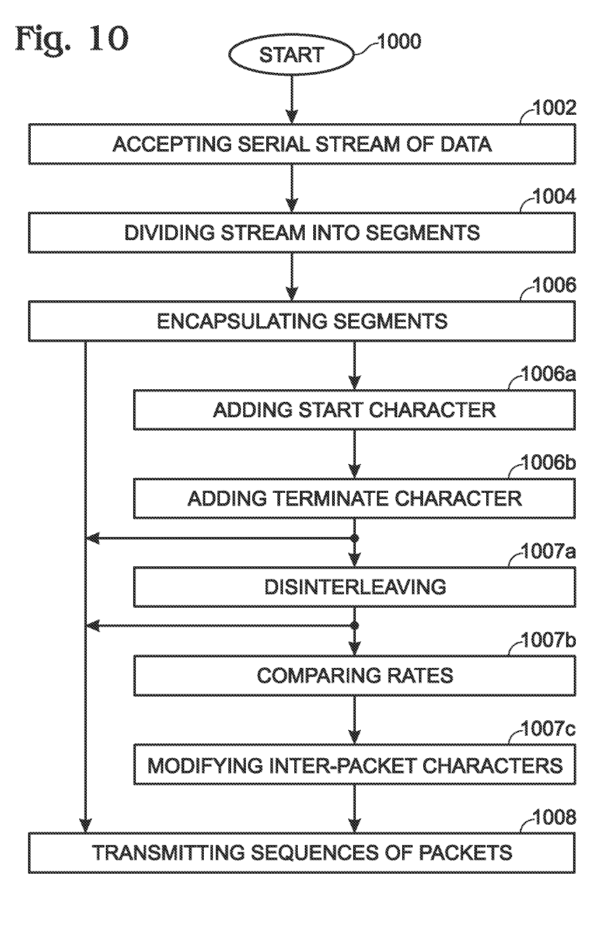

FIG. 10 is a flowchart illustrating a method for transporting digital information via a MAUI interface. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 1000.

At a transmitter, Step 1002 accepts an electromagnetic waveform representing a synchronous serial stream of digital information. Step 1004 divides the serial stream into a sequence of segments. Step 1006 encapsulates the segments, creating a sequence of packets with the following substeps. Step 1006a adds a start character to the beginning of each segment. Step 1006b adds a terminate character to the end of each segment. Step 1008 asynchronously transmits an electromagnetic waveform representing the sequence of packets.

In one aspect, dividing the serial stream into the sequence of segments in Step 1004 includes selecting the size of each segment, and transmitting the sequence of packets in Step 1008 includes transmitting a sequence of variable-length packets.

In another aspect an additional step, Step 1007a disinterleaves each segment across m lanes. For example, accepting the synchronous serial stream of digital information in Step 1002 includes accepting the serial stream at a first data rate. Then, Step 1007a creates equal-rate disinterleavered lanes at a second data rate, whose combination is effectively equal to the first data rate, with compensation for added encapsulation characters.

Step 1007a compensates for added encapsulation characters such as post-start characters added subsequent to the start character, inter-packet characters added subsequent to the termination character, and a combination of post-start and inter-packet characters. The post-start and inter-packet characters may be idle characters, fill-data characters, or in-band communication channel characters. That is, the rate of each lane is greater than the (first rate)/m to compensate for the added encapsulation characters.

In one aspect, accepting the synchronous serial stream of digital information in Step 1002 includes accepting frames of information, where each frame includes at least one frame alignment character at the start of each frame. Then, adding a start character to the beginning of each segment (Step 1006a) includes replacing the alignment character with a start character, see FIG. 6.

In another aspect, Step 1006a adds the start character as the first character in lane 0 of m lanes, and Step 1007a disinterleaves a first word in the segment into lane 1, subsequent to the start character. Step 1006b adds the terminate character into lane x, subsequent to the last word in the segment. Step 1006 also adds inter-packet characters to lanes (x+1) through (m−1), subsequent to the terminate character, see FIGS. 6-8.

In another aspect, Step 1006 adds the start character as the first character in lane 0 of m lanes, and adds post-start characters to (x−1) lanes subsequent to the start character. Step 1007a disinterleaves a first word in the segment into lane x, subsequent to a last post-start character. Then, Step 1006 adds the terminate character subsequent to the last word in the segment and adds inter-packet characters subsequent to the terminate character, see FIG. 5.

In one aspect Step 1007a disinterleaves lanes at a second data rate by filling m transmit buffers, each at the second data rate, and asynchronously transmitting the sequence of packets in Step 1008 includes transmitting each lane at a third data rate. Then, Step 1007b compares the second data rate to the third data rate, and Step 1007c modifies the number of inter-packet characters to compensate for differences between the second and third data rates.

A system and method have been provided for transporting digital information via a MAUI or XAUI-like interface. Examples, of particular circuitry and protocols have been given to illustrate the invention. However, the invention is not limited to merely these examples. Likewise, examples have been given in the context of the XAUI protocol and particular data rates. Again the invention is not limited to these examples. Other variations and embodiments of the invention will occur to those skilled in the art.

We claim:

1. A method for transporting digital information via a modified Attachment Unit Interface (MAUI) interface, the method comprising:
at a transmitter, accepting an electromagnetic waveform representing a synchronous serial stream of digital information;
dividing the serial stream into a sequence of segments;
encapsulating the segments, creating a sequence of packets as follows:
adding a start character to the beginning of each segment;
adding a terminate character to the end of each segment; and,
asynchronously transmitting an electromagnetic waveform representing the sequence of packets.

2. The method of claim 1 wherein dividing the serial stream into the sequence of segments includes selecting the size of each segment; and,
wherein transmitting the sequence of packets includes transmitting a sequence of variable-length packets.

3. The method of claim 1 further comprising:
disinterleaving each segment across m lanes.

4. The method of claim 3 wherein accepting the synchronous serial stream of digital information includes accepting the serial stream at a first data rate; and,
wherein disinterleaving each segment across m lanes includes creating equal-rate disinterleavered lanes at a second data rate, whose combination is effectively equal to the first data rate, with compensation for added encapsulation characters.

5. The method of claim 4 wherein compensating for added encapsulation characters includes compensating for encapsulation characters selected from a group consisting of post-start characters added subsequent to the start character, inter-packet characters added subsequent to the termination character, and a combination of post-start and inter-packet characters.

6. The method of claim 5 wherein adding post-start and inter-packet characters includes adding characters selected from a group consisting of idle characters, fill-data characters, and in-band communication channel characters.

7. The method of claim 4 wherein accepting the synchronous serial stream of digital information includes accepting frames of information, where each frame includes at least one frame alignment character at the start of each frame; and,
wherein adding a start character to the beginning of each segment includes replacing the alignment character with a start character.

8. The method of claim 5 wherein encapsulating the segments includes adding the start character as the first character in lane 0 of m lanes;
wherein disinterleaving each segment across the m lanes includes disinterleaving a first word in the segment into lane 1, subsequent to the start character;
wherein encapsulating the segments further includes:
adding the terminate character into lane x, subsequent to the last word in the segment; and,
adding inter-packet characters to lanes (x+1) through (m−1), subsequent to the terminate character.

9. The method of claim 5 wherein encapsulating the segments includes:
adding the start character as the first character in lane 0 of m lanes;
adding post-start characters to (x−1) lanes subsequent to the start character;
wherein disinterleaving each segment across the m lanes includes disinterleaving a first word in the segment into lane x, subsequent to a last post-start character;
wherein encapsulating the segments further includes:
adding the terminate character subsequent to the last word in the segment; and,
adding inter-packet characters subsequent to the terminate character.

10. The method of claim 4 wherein creating the disinterleaved lanes at a second data rate includes filling m transmit buffers, each at the second data rate;
wherein asynchronously transmitting the sequence of packets includes transmitting each lane at a third data rate;
the method further comprising:
comparing the second data rate to the third data rate; and,
modifying the number of inter-packet characters to compensate for differences between the second and third data rates.

11. A device for the transport of digital information via a modified Attachment Unit Interface (MAUI) interface, the device comprising:
an encapsulation module having an upper level interface to accept an electromagnetic waveform representing a synchronous serial stream of digital information, the encapsulation module dividing the serial stream into a sequence of segments, encapsulating each segment and creating a packet by adding a start character to the beginning of each segment and a terminate character to the end of each segment, and supplying a sequence of packets; and,
a transmitter having an interface to accept the sequence of packets and a network interface for asynchronously transmitting an electromagnetic waveform representing the sequence of packets.

12. The device of claim 11 wherein the encapsulation module selects the size of each segment; and,
wherein the transmitter transmits a sequence of variable-length packets.

13. The device of claim 11 further comprising:
a disinterleaver interposed between the encapsulation module and the transmitter, the disinterleaver accepting the sequence of packets and supplying each segment disinterleaved across m lanes; and,
wherein the transmitter has m parallel input interfaces to accept the disinterleaved lanes and m parallel network interfaces corresponding to the m lanes.

14. The device of claim 13 wherein the encapsulation module accepts the serial stream at a first data rate; and,
wherein the disinterleaver creates equal-rate lanes at a second data rate, whose combination is effectively equal to the first data rate, with compensation for added encapsulation characters.

15. The device of claim 14 wherein the disinterleaver compensates for encapsulation characters selected from a group consisting of post-start characters added subsequent to the start character, inter-packet characters added subsequent to the termination character, and a combination of post-start and inter-packet characters.

16. The device of claim 15 wherein the disinterleaver adds post-start characters and inter-packet characters, each selected from a group consisting of idle characters, fill-data characters, and in-band communication channel characters.

17. The device of claim 14 wherein the encapsulation module accepts frames of information, where each frame includes at least one frame alignment character at the start of each frame, and replaces the alignment character with a start character.

18. The device of claim 15 wherein the encapsulation module adds the start character as the first character in lane 0 of m lanes, and the terminate character into lane x, subsequent to the last word in the segment; and,
wherein the disinterleaver disinterleaves a first word in the segment into lane 1, subsequent to the start character, and adds inter-packet characters to lanes (x+1) through (m−1), subsequent to the terminate character.

19. The device of claim 15 wherein the encapsulation module adds the start character as the first character in lane 0 of m lanes, and the terminate character subsequent to the last word in the segment; and,
wherein the disinterleaver adds post-start characters to (x−1) lanes subsequent to the start character, disinterleaves a first word in the segment into lane x subsequent to a last post-start character, and adds inter-packet characters to lanes subsequent to the terminate character.

20. The device of claim 14 wherein the transmitter includes m transmit buffers, each buffer filling from a corresponding lane at the second data rate, the transmitter comparing the second data rate to a third data rate, modifying the number of inter-packet characters to compensate for differences between the second and third data rates, and draining each buffer at the third data rate for transmission.

21. A device for the receiving digital information via a modified Attachment Unit Interface (MAUI) interface, the device comprising:
a receiver having a network interface to accept an electromagnetic waveform representing an asynchronously sequence of packets and an interface to supply the sequence of packets;
an decapsulation module having an interface to accept the sequence of packets, the decapsulation module decapsulating each packet, creating segments by removing a start character from the beginning of each packet and a terminate character from the end of each segment, and combining segments to supply an electromagnetic waveform representing a synchronous serial stream of digital information via an upper level interface.
